(19) United States
(12) Patent Application Publication
(10) Pub. No.: US 2025/0361896 A1
(43) Pub. Date: Nov. 27, 2025

(54) ROTATABLE QUICK DISCONNECT COUPLING SYSTEM

(71) Applicant: NIKE, Inc., Beaverton, OR (US)

(72) Inventors: Austin J. Orand, Portland, OR (US); Richard K. Hansen, Vancouver, WA (US)

(73) Assignee: NIKE, Inc., Beaverton, OR (US)

(21) Appl. No.: 19/219,714

(22) Filed: May 27, 2025

Related U.S. Application Data
(60) Provisional application No. 63/651,940, filed on May 24, 2024.
(60) Provisional application No. 63/651,435, filed on May 24, 2024.

(51) Int. Cl. F16B 5/06; A41D 1/00; A43C 11/00

(52) U.S. Cl. CPC F16B 5/0621; A41D 1/00; A43C 11/00

(57) ABSTRACT

A rotatable quick disconnect coupling system for apparel and footwear applications provides secure attachment and detachment between components while enabling rotational movement. The system includes a keyed post with a non-radially symmetric cross-sectional profile that inserts into a receiver with a complementary internal profile, preventing unintended rotation of the post within the receiver. A spring-biased latching protrusion extends from the keyed post to engage a retention edge of the receiver when fully inserted. A user-activated release mechanism allows easy detachment by retracting the latching protrusion, via configurations such as an upstanding tab or a push-button. A bearing shaft extending from the keyed post rotatably couples with an annular portion of a connected component, enabling rotational movement while maintaining secure attachment.

### CROSS-REFERENCE TO RELATED APPLICATION

This application claims the benefit of priority to U.S. Provisional Application No. 63/651,940, filed May 24, 2024, and U.S. Provisional Application No. 63/651,435, filed May 24, 2024, both of which are incorporated by reference in their entirety.

### TECHNICAL FIELD

The present disclosure relates generally to connection systems for apparel and footwear, and more particularly to quick disconnect coupling mechanisms that provide both secure attachment and rotational capability.

### BACKGROUND

Quick connect and disconnect mechanisms are utilized across numerous industries, including the apparel and footwear sectors, to facilitate the attachment and detachment of components. In sectors such as athletic footwear, performance apparel, and sporting equipment, there is growing interest in coupling mechanisms that can provide multiple functional capabilities in a single system.

Connection systems for apparel and related fields typically employ various design approaches to address different functional requirements, including threaded connections, friction fits, hook-and-loop fasteners, and mechanical latching mechanisms. However, each of these approaches generally addresses only a single functional requirement.

In dynamic applications where components may need to pivot relative to one another, it would be desirable to provide rotational capabilities in addition to secure attachment functionality. For applications requiring frequent assembly and disassembly, it would be beneficial to minimize the complexity of user operations and reduce the force requirements for engagement and disengagement. In athletic footwear and performance apparel applications, it would be advantageous to have coupling mechanisms that combine secure attachment with ease of use in a compact form factor. Additionally, it would be desirable to provide reliable locking mechanisms that resist unintended disconnection during physical activities while still permitting rapid intentional release when needed.

For modular apparel systems and customizable footwear applications, it would be beneficial to enable rapid reconfiguration of components while maintaining secure connections during use. The ability to combine secure mechanical attachment, intuitive operation, and controlled rotational movement in a single coupling system would provide significant advantages for various applications across the apparel and footwear industries.

### SUMMARY

The present disclosure provides a rotatable quick disconnect coupling system that addresses the technical challenges of providing secure yet readily detachable connections between components in apparel and footwear applications while enabling controlled rotational movement. The coupling system offers a streamlined solution that combines mechanical security, user-friendly operation, and articulated movement capability in a compact form factor suitable for diverse applications across athletic footwear, performance apparel, and modular accessory systems.

The rotatable quick disconnect coupling system comprises a keyed post having a non-radially symmetric cross-sectional profile that is configured to be inserted within a receiver having a complementary internal profile. This geometric relationship prevents unintended rotation of the keyed post within the receiver while facilitating proper alignment during insertion.

A latching mechanism includes a latching protrusion that selectively extends proud of an outer surface of the keyed post to engage with a retention edge of the receiver when the keyed post is fully inserted, providing secure retention until intentional release is desired. A user-activated release mechanism is configured to retract the latching protrusion, allowing removal of the keyed post from the receiver through intuitive operation. The release mechanism may comprise an upstanding tab coupled to the latching protrusion, optionally enhanced with a pull tab or fabric loop to facilitate activation. Alternative embodiments may incorporate a push-button configuration.

A bearing shaft extends from the keyed post and is rigidly coupled thereto. The bearing shaft is configured to rotatably couple with an annular portion of a connected component to form a rotatable joint that permits rotation about an axis substantially parallel to a longitudinal axis of the bearing shaft. This arrangement enables connected components to articulate relative to one another while maintaining secure mechanical attachment.

In footwear applications, the coupling system may be integrated into articles of footwear, where a receiver is secured to a portion of the footwear and configured to accept a keyed post extending from connected components such as support structures, performance enhancement elements, lighting elements, or detachable accessories. The receiver may be embedded within a heel region, sole structure, or heel counter.

In apparel applications, the coupling system may be integrated into articles of apparel having a primary garment structure and modular apparel components. A receiver secured to the primary garment structure receives a keyed post extending from the modular apparel component, such as hoods, protective panels, pockets, or functional accessories.

The system's non-radially symmetric keyed post and receiver profile ensures proper alignment and prevents unintended rotation. The spring-biased latching protrusion delivers reliable retention and enables rapid release. The bearing shaft assembly provides controlled rotational capability. The system is scalable and adaptable, using materials like aluminum, reinforced polymers, or composites.

### BRIEF DESCRIPTION OF THE DRAWINGS

The accompanying drawings, which are incorporated in and constitute a part of this specification, illustrate various embodiments of the rotatable quick disconnect coupling system and, together with the detailed description, serve to explain the principles of the design.

FIG. 1 is an exploded view of an embodiment of a rotatable quick disconnect coupling system showing the individual components in a disassembled state.

FIG. 2 is a perspective view of the rotatable quick disconnect coupling system of FIG. 1 in an assembled state, illustrating the keyed post inserted within the receiver with the user-activated release mechanism visible.

FIG. 3 is a perspective view of the rotatable quick disconnect coupling system showing the bearing shaft assembly and connected component configuration in a footwear application context.

FIG. 4 is a cross-sectional view of the rotatable quick disconnect coupling system taken through the latching mechanism, showing internal details of the latching protrusion, spring element, and retention edge engagement.

FIG. 5 is a side view of a footwear application showing integration of the rotatable quick disconnect coupling system with an article of footwear, illustrating attachment of a lighting element as a connected component.

FIG. 6 is a perspective view of an apparel application showing integration of the rotatable quick disconnect coupling system with a primary garment structure and modular apparel component, illustrating attachment of a water bottle accessory to a backpack.

### DETAILED DESCRIPTION

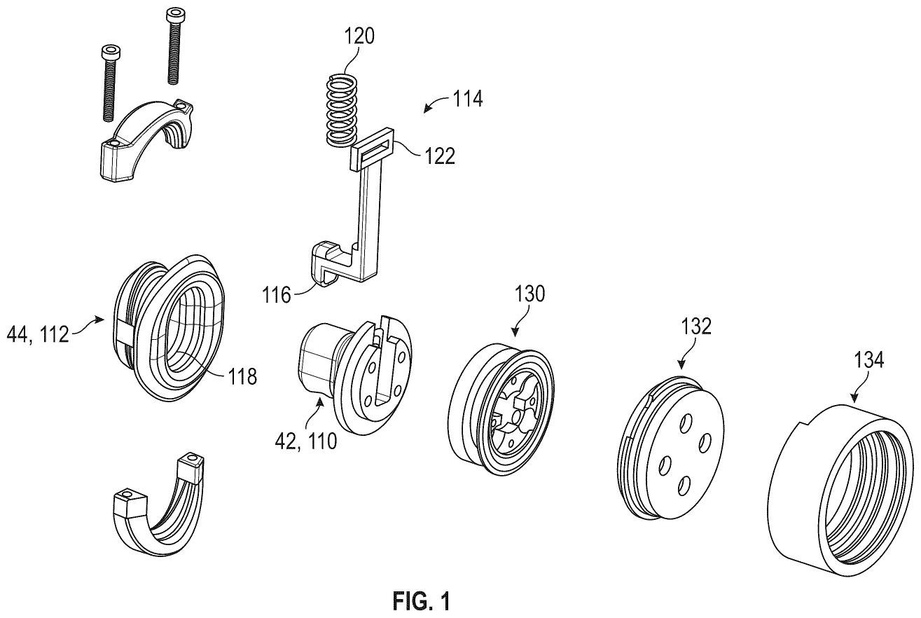

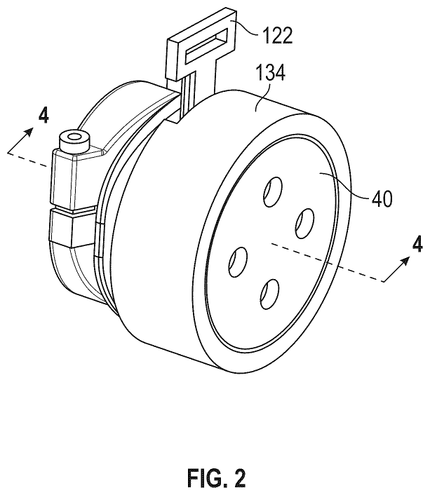

The present disclosure is directed to a rotatable quick disconnect coupling system 40 designed for secure attachment and detachment between components in apparel and footwear applications while enabling controlled rotational movement. The coupling system 40 addresses the need for reliable, user-friendly connection mechanisms in athletic footwear, performance apparel, and modular garment applications where both mechanical security and articulated movement are essential for optimal functionality. Referring to the figures, where like numerals refer to common elements, FIGS. 1 and 2 illustrate the rotatable quick disconnect coupling system 40 in disassembled and assembled states, respectively.

### Basic Structural Elements

As shown in FIGS. 1-4, the rotatable quick disconnect coupling system 40 comprises a keyed post 110 configured to be inserted within a receiver 112. The keyed post 110 has a non-radially symmetric cross-sectional profile (e.g., oval, elliptical, D-shape, triangular, or polygonal) that corresponds to a complementary internal profile of the receiver 112. This geometric relationship facilitates proper alignment during insertion and prevents unintended rotation of the keyed post 110 within the receiver 112, ensuring that connected components maintain their intended orientation. The profile selection may be influenced by load distribution, space constraints, and manufacturing considerations. For instance, simpler profiles like oval or D-shapes may suit lightweight apparel, while complex polygonal shapes may be better for enhanced rotational stability. The keyed post 110 and receiver 112 are precision-engineered for a secure fit with minimal play. Components may be constructed from durable materials like aluminum, reinforced polymers, or composite materials, chosen for strength, weight, and durability appropriate to the application.

### Latching Mechanism

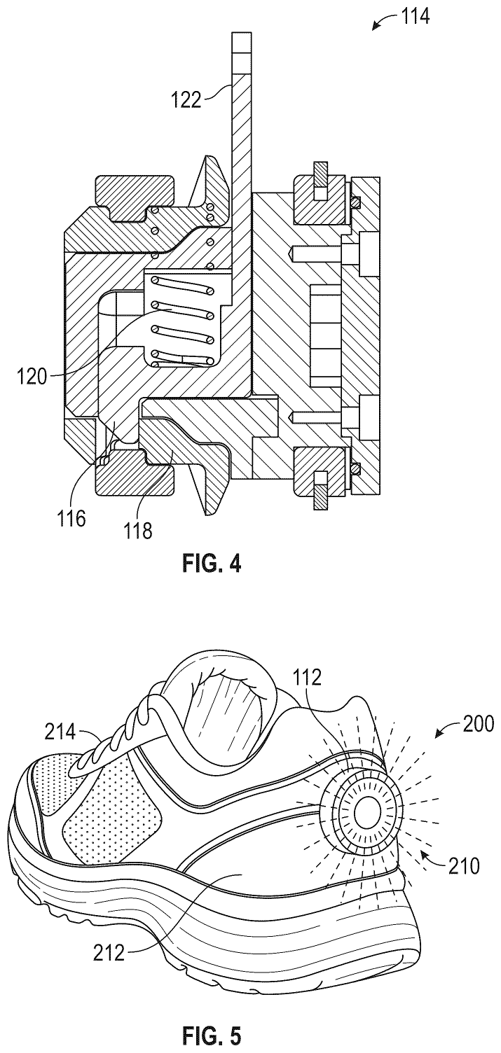

Illustrated in FIGS. 1 and 4, the system 40 includes a latching mechanism 114 with a latching protrusion 116 configured to selectively extend proud of an outer surface of the keyed post 110. When the keyed post 110 is fully inserted into the receiver 112, the latching protrusion 116 engages a corresponding retention edge 118 of the receiver 112, securing the connection. The latching protrusion 116 is biased in its extended position by a spring element 120 (e.g., compression spring, leaf spring). The spring force is calibrated to resist accidental disconnection during dynamic activities while permitting easy user-activated release, with typical release forces ranging from approximately 2 to 15 pounds, adjustable based on application requirements.

### User-Activated Release Mechanism

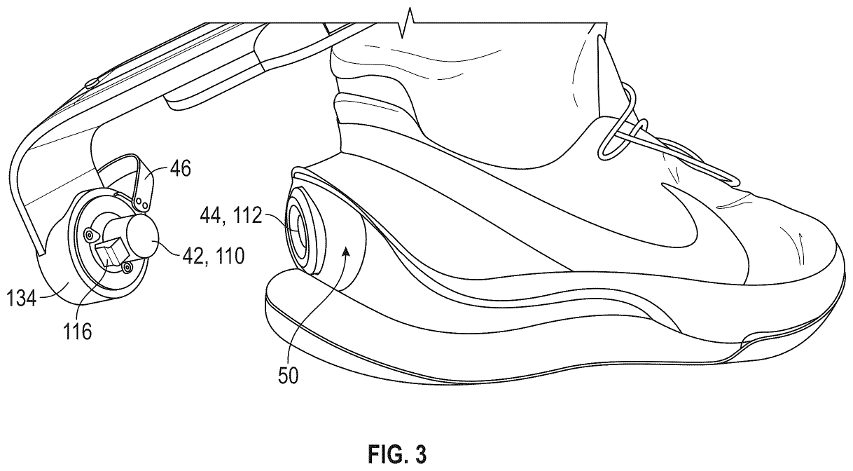

The system 40 incorporates a user-activated release mechanism to retract the latching protrusion 116, allowing removal of the keyed post 110 from the receiver 112. In one embodiment (FIGS. 1-4), this is an upstanding tab 122 coupled to the latching protrusion 116. A pull tab or fabric loop 46 (FIG. 3) can be coupled to the upstanding tab 122 to facilitate one-handed activation, even with gloved hands. Pulling the tab 122 or loop 46 overcomes the spring bias, retracting the latching protrusion 116 and allowing withdrawal of the keyed post 110. Alternative embodiments may use a push-button release mechanism, which may be preferable where a pull tab is undesirable aesthetically or functionally. The push-button can be variously positioned on the keyed post 110.

### Rotational Bearing Assembly

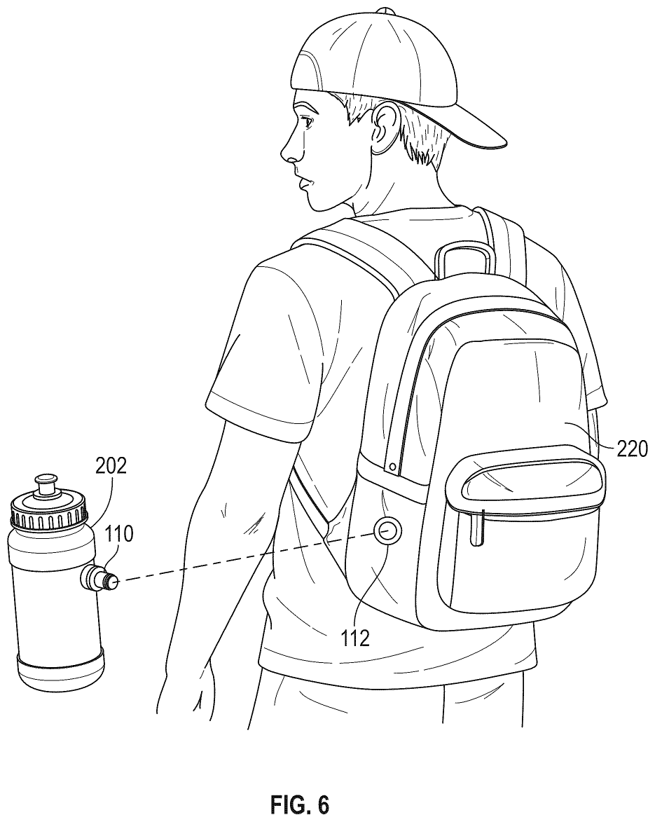

As seen in FIGS. 1-4, a bearing shaft 130 extends from and is rigidly coupled to the keyed post 110. A retaining cap 132 is positioned at the end of the bearing shaft 130 opposite the keyed post 110. An annular portion 134 of a connected component (e.g., component 50 in FIG. 3, lighting element 200 in FIG. 5, water bottle 202 in FIG. 6) encircles and is rotatably coupled to the bearing shaft 130, forming a rotatable joint. The retaining cap 132 axially retains the annular portion 134 on the bearing shaft 130 while permitting rotational movement about an axis substantially parallel to the bearing shaft's longitudinal axis. To facilitate smooth operation, one or more bearing elements (e.g., roller bearings, ball bearings, sleeve bearings) may be positioned between the bearing shaft 130 and the annular portion 134. This rotational capability allows connected components to pivot while maintaining secure attachment, enhancing performance and comfort. The total rotation may be limited to a predetermined angular range, for example, through the use of mechanical stops integrated into the bearing shaft 130 or the annular portion 134, as the keyed post's 110 non-rotation within the receiver 112 provides a stable base.

### Integration and Mounting Configurations

The system 40 can be integrated via various mounting configurations. The receiver 112 may be embedded, surface-mounted using mechanical fasteners, adhered using industrial adhesives, or incorporated during the manufacturing process. The keyed post 110 assembly can be attached to corresponding components through threaded connections, press-fitting, or other suitable joining methods. Dimensions may be scaled for different applications, from lightweight garments to robust footwear, without altering fundamental principles. In some embodiments, the coupling system may further include environmental sealing elements, such as O-rings or gaskets, positioned to inhibit ingress of moisture or debris, for example, at an interface between the keyed post 110 and receiver 112, or within the rotatable joint.

FIG. 5 illustrates a footwear application where the receiver 112 may be embedded in a heel region 210, a sole structure, or a heel counter 212 of an article of footwear 214. Connected components can include support structures, performance enhancement elements, lighting elements 200 (as in FIG. 5), or detachable accessories. For example, detachable lighting elements 200 allow users to quickly attach illumination devices for visibility during low-light activities and remove them when not required. The rotational capability permits the lighting element to adjust to optimal positioning while maintaining secure attachment during dynamic movement. Another footwear application involves adjustable support or mobility-assist elements. The rotational capability permits the support element to adjust to natural foot and ankle motion during use. The user-activated release mechanism is accessible from outside the article of footwear, enabling rapid disconnection.

FIG. 6 shows an apparel application, where a receiver 112 is secured to a primary garment structure (e.g., a jacket, a vest, a pair of pants, a backpack 220 as in FIG. 6, or athletic equipment) and a keyed post 110 is attached to a modular apparel component. Modular components may comprise at least one of a hood, a protective panel, a pocket, a storage compartment (like a water bottle 202 as in FIG. 6), a thermal element, or a functional accessory. This configuration enables wearers to quickly attach or detach functional elements based on changing environmental conditions or activity requirements. The rotational capability allows these elements to better conform to body movements during use, enhancing comfort and functionality. For example, in cycling apparel, aerodynamic elements can be attached, or in modular layering systems, insulative components can be added or removed. Multiple rotatable quick disconnect coupling systems may be positioned at different locations on a primary garment structure to enable modular reconfiguration of multiple apparel components. The receiver may be integrated into a backpack, bag, purse, or similar article to facilitate connection of additional storage options or beverage containers.

The system can be adapted for athletic equipment and outdoor gear, enabling modular organization systems. In backpack and athletic equipment bag applications, it enables modular compartment systems. The coupling system may also incorporate additional features such as integrated electrical connections that engage automatically when the mechanical coupling is secured, enabling power and data transfer between connected components. This is valuable for electronic devices, lighting elements, or sensor systems. For instance, it may facilitate the selective attachment and electrical connection of a battery operative to power an article of apparel with integrated electronics. In other applications, the system may serve as a closure mechanism for an article of footwear, where the keyed post 110 is attached to a strap operative to adjust the fit, potentially combined with ratcheting cord-based tensioners.

### Performance Characteristics and Materials

The system is designed for reliability across a range of environmental conditions typical of apparel and footwear applications. The latching mechanism is calibrated for secure retention and easy user-activated release. The rotational bearing assembly is designed for smooth operation with minimal friction while maintaining structural integrity under operational loads. Component materials are selected based on specific requirements, including load, environmental exposure, weight, and aesthetics. Aluminum alloys offer excellent strength-to-weight ratios, reinforced polymers provide design flexibility and cost advantages, and composite materials may be used for specialized applications. Manufacturing processes ensure consistent dimensional accuracy and surface finish quality essential for proper operation.

The described rotatable quick disconnect coupling system represents a significant advancement in connection technology, combining secure attachment, intuitive release operation, and controlled rotational capability in a compact design. This enables innovative functionality in performance footwear, modular garments, and athletic equipment, enhancing user experience, product versatility, and operational performance.

Additional disclosure of features and alternate/additional uses for the rotatable quick disconnect coupling are described in U.S. patent application Ser. No. 19/219,653, filed 27 May 2025, entitled Motorized Ambulatory Assist Device, the entire disclosure of which is incorporated by reference in its entirety and for everything that it discloses.

1. A rotatable quick disconnect coupling system comprising:
a keyed post having a non-radially symmetric cross-sectional profile;
a receiver configured to receive the keyed post, the receiver having an internal profile complementary to the non-radially symmetric cross-sectional profile of the keyed post to prevent rotation of the keyed post within the receiver;
a latching mechanism including a latching protrusion configured to selectively extend proud of an outer surface of the keyed post and engage with a retention edge of the receiver when the keyed post is fully inserted into the receiver;
a user-activated release mechanism configured to retract the latching protrusion to allow removal of the keyed post from the receiver; and
a bearing shaft extending from the keyed post and rigidly coupled thereto, the bearing shaft configured to rotatably couple with an annular portion of a connected component to form a rotatable joint, the rotatable joint permitting rotation about an axis substantially parallel to a longitudinal axis of the bearing shaft.

2. The system of claim 1, wherein the non-radially symmetric cross-sectional profile of the keyed post comprises one of an oval shape, an elliptical shape, a D-shape, a triangular shape, or a polygonal shape.

3. The system of claim 1, wherein the latching protrusion is biased in an extended position by a spring element.

4. The system of claim 1, wherein the user-activated release mechanism comprises an upstanding tab coupled to the latching protrusion.

5. The system of claim 4, further comprising at least one of a pull tab or a fabric loop coupled to the upstanding tab to facilitate activation of the release mechanism.

6. The system of claim 1, wherein the user-activated release mechanism comprises a push-button configured to retract the latching protrusion when pressed.

7. The system of claim 1, wherein the bearing shaft includes a retaining cap positioned at an end of the bearing shaft opposite from the keyed post, the retaining cap configured to axially retain the annular portion of the connected component on the bearing shaft while permitting rotational movement.

8. The system of claim 1, wherein the rotatable joint comprises one or more bearing elements positioned between the bearing shaft and the annular portion of the connected component.

9. The system of claim 8, wherein the one or more bearing elements are selected from the group consisting of roller bearings, ball bearings, and sleeve bearings.

10. The system of claim 1, further comprising a mechanical stop configured to limit a range of rotational movement of the annular portion relative to the bearing shaft.

11. The system of claim 1, further comprising integrated electrical connections configured to provide electrical communication between the keyed post or the bearing shaft and the connected component when the keyed post is inserted into the receiver.

12. The system of claim 1, further comprising one or more sealing elements configured to inhibit ingress of environmental contaminants into an interface between the keyed post and the receiver or within the rotatable joint.

13. The system of claim 1, wherein the keyed post and the receiver are made from at least one of aluminum, reinforced polymer, or composite material.

14. An article of footwear comprising:
a sole structure;
an upper secured to the sole structure; and
a rotatable quick disconnect coupling system comprising:
a receiver secured to a portion of the article of footwear, the receiver having an internal profile with a non-radially symmetric cross-section, which is complementary to a non-radially symmetric cross-sectional profile of a keyed post to prevent rotation of the keyed post within the receiver;
the keyed post having the corresponding non-radially symmetric cross-sectional profile configured to be inserted into the receiver;
a latching mechanism configured to secure the keyed post within the receiver, the latching mechanism including a spring-biased latching protrusion that extends proud of an outer surface of the keyed post to engage with a retention edge of the receiver;
a user-activated release mechanism accessible from outside the article of footwear and configured to disengage the latching mechanism to allow removal of the keyed post from the receiver; and
a bearing shaft extending from the keyed post, the bearing shaft configured to rotatably couple with an annular portion of a connected component to enable rotational movement of the connected component relative to the article of footwear.

15. The article of footwear of claim 14, wherein the receiver is embedded within at least one of a heel region, the sole structure, or a heel counter of the article of footwear.

16. The article of footwear of claim 14, wherein the connected component comprises at least one of a support structure, a performance enhancement element, a lighting element, or a detachable accessory for the article of footwear.

17. The article of footwear of claim 14, wherein the user-activated release mechanism comprises one of an upstanding tab or a push-button mechanism.

18. An article of apparel comprising:
a primary garment structure; and
a rotatable quick disconnect coupling system comprising:
a receiver secured to the primary garment structure, the receiver having an internal profile with a non-radially symmetric cross-section, which is complementary to a non-radially symmetric cross-sectional profile of a keyed post to prevent rotation of the keyed post within the receiver;
the keyed post having the corresponding non-radially symmetric cross-sectional profile configured to be inserted into the receiver;
a latching mechanism configured to secure the keyed post within the receiver, the latching mechanism including a spring-biased latching protrusion that extends proud of an outer surface of the keyed post to engage with a retention edge of the receiver when the keyed post is fully inserted;
a user-activated release mechanism configured to disengage the latching mechanism to allow removal of the keyed post from the receiver; and
a bearing shaft extending from the keyed post, the bearing shaft configured to rotatably couple with an annular portion of a modular apparel component to enable rotational movement of the modular apparel component relative to the primary garment structure.

19. The article of apparel of claim 18, wherein the modular apparel component comprises at least one of a hood, a protective panel, a pocket, a storage compartment, a thermal element, or a functional accessory.

20. The article of apparel of claim 18, wherein the primary garment structure comprises at least one of a jacket, a vest, a pair of pants, a backpack, or athletic equipment.

21. The article of apparel of claim 18, comprising a plurality of rotatable quick disconnect coupling systems positioned at different locations on the primary garment structure to enable modular reconfiguration of multiple apparel components.

22. The article of apparel of claim 18, wherein the bearing shaft includes a retaining cap positioned at an end opposite from the keyed post, the retaining cap configured to axially retain the annular portion of the modular apparel component while permitting rotational movement about the bearing shaft.
